(19) United States
(12) Patent Application Publication
(10) Pub. No.: US 2005/0104571 A1
(43) Pub. Date: May 19, 2005

(54) Power-up signal generating circuit

(75) Inventors: Sang Jin Byeon, Seoul (KR); Kee Teok Park, Gyeonggi-do (KR)

Correspondence Address: MARSHALL, GERSTEIN & BORUN LLP, 6300 SEARS TOWER, 233 S. WACKER DRIVE, CHICAGO, IL, 60606, US

(73) Assignee: HYNIX SEMICONDUCTOR INC., Kyungki-Do (KR)

(21) Appl. No.: 10/745,227

(22) Filed: Dec. 23, 2003

(30) Foreign Application Priority Data
Nov. 13, 2003 (KR) 2003-80049

(51) Int. Cl. G05F 1/40

(52) U.S. Cl. 323/288

(57) ABSTRACT

Provided is A power-up signal generating circuit, comprising: a voltage sensing unit for sensing that a potential of an external power source voltage is above a certain potential, the voltage sensing unit comprising a first switching element operated according to the external power source voltage and a resistor serially connected to the first switching element; a power-up signal generating unit for generating a power-up signal according to an output signal of the voltage sensing unit, the power-up generating unit comprising a second switching element; and a buffering unit for buffering the power-up signal from the power-up signal generating unit up to a certain potential and outputting the buffered power-up signal, wherein a timing of generating the power-up signal is controlled by the second switching element being turned on and off according to a threshold voltage of the first switching element.

### BACKGROUND

1. Field of the Invention

The invention relates generally to a power-up signal generating circuit as an internal power source generating apparatus which is used for improving reliability of operation of a circuit in a semiconductor device, and more particularly, to a power-up signal generating circuit capable of reducing a variation of a power-up signal, that is, a skew.

2. Discussion of Related Art

Recently, as the design rule has fined down rapidly, a potential of a core voltage that is applied to a cell has been lowered, whereby a process variation is increased right after power source is supplied.

Generally, a power-up signal generating circuit generates a power-up signal, which is used to sense that a substrate bias voltage Vbb becomes a desired voltage level, and controls certain nodes or power-using unit internal power sources are stabilized and set up.

FIG. 1 shows a conventional power-up signal generating circuit that comprises resistor elements. The power-up signal generating circuit shown in FIG. 1 comprises a voltage sensing unit 1, a level control unit 2, a power-up signal generating unit 3 and a buffering unit 4.

In the conventional one, problems exist in the voltage sensing unit 1 comprising resistors R0 and R1, which are connected in serial between an external power source voltage Vext and a ground voltage Vss.

As the external power source voltage Vext rises from 0V to a target voltage, a PMOS transistor P1 and an NMOS transistor N1 have a threshold voltage Vt, respectively. Therefore, a DRAM chip has a voltage of 2Vt, which is the sum of the threshold voltages Vt of the PMOS and NMOS transistors in order to stabilize its operational areas. The potentials of the internal power sources generated by the external power source voltage Vext become above certain levels in order that the chip can perform its stable operations. For the purpose of controlling such operations, it is very important to keep a timing of enabling the power-up signal constant in order to stabilize the chip.

However, the power-up signal generated in the conventional circuit has a seriously wide variation. This is because the threshold voltage of the NMOS transistor N1 is high. The voltage of the node A, which is inputted to the gate of the NMOS transistor N1, is 1/2*Vext by voltage-division of the resistors R0 and R1, and thus, the variation occurs to be twice as much as the threshold voltage of the NMOS transistor N1 when the power-up signal is generated. As the design rule for the semiconductor memory devices has been fined down and the core voltage used for the cell has been further lowered, the timing of driving the power-up has begun earlier and the initial variation of the power-up signal has been seriously deteriorated. Therefore, the conventional power-up signal generating circuit may cause many problems in the initial stability and reliability of the chip.

Now, the conventional power-up signal generating circuit shown in FIG. 1 will be additionally described.

Referring to FIG. 1, the power-up signal generating circuit of FIG. 1 comprises a voltage sensing unit 1 for sensing that a potential of a power source voltage is above a certain voltage, that is, 2Vt; a level control unit 2 for controlling an operation of the NMOS transistor N1 when an output voltage of the voltage sensing unit 1 is above a certain voltage; a power-up signal generating unit 3 for generating a power-up signal according to an output signal of the level control unit 2; and a buffering unit 4 for receiving an output signal det of the power-up signal generating unit 3, buffering a power-up signal pwrup up to a certain voltage level, and outputting the buffered power-up signal.

The voltage sensing unit 1 comprises the resistors R0 and R1 which are connected in serial between an external power source voltage Vext and a ground voltage Vss. The level control unit 2 comprises an NMOS transistor N0, which functions as a reverse diode device, in which the ground voltage Vss is applied to the bulk. The gate and source of the NMOS transistor N0 are commonly connected to a connection node A between the resistors R0 and R1. The external voltage source Vext is applied to the drain of the NMOS transistor N0.

The power-up signal generating unit 3 comprises a PMOS transistor P1 and an NMOS transistor N1 which are connected in serial between the external power source voltage Vext and the ground voltage Vss. The gate of the PMOS transistor P1 is connected to the ground voltage Vss. The source and bulk of the PMOS transistor P1 are connected to the external power source voltage Vext. The drain of the PMOS transistor P1 is connected to the drain of the NMOS transistor N1. The voltage of the node A is applied to the gate of the NMOS transistor N1. The ground voltage Vss is applied to the bulk of the NMOS transistor N1.

The buffering unit 4 comprises an inverter I1 for buffering the output signal det from the power-up signal generating unit 3 and outputting the power-up signal pwrup as one of the voltage levels of the external power source voltage Vext and the ground voltage Vss.

In FIG. 1, if the voltage of the node A is inputted to the level control unit 2 and the voltage of the node A is above a certain voltage, the NMOS transistor N0 is turned on and the voltage of the external power source voltage Vext is applied to the gate of the NMOS transistor N1, so that the NMOS transistor N1 can be operated. In other words, if the NMOS transistor N1 is turned on by the voltage of the node A, a ‘low’ signal is outputted to the output node det by the PMOS resister P1 which is connected to the external power source voltage Vext, and the power-up signal as a ‘high’ signal is outputted through the buffering unit 4.

FIG. 2 shows simulation results for the conventional circuit shown in FIG. 1.

Referring to the simulation results in FIG. 2, the changes of the voltages at the external power source voltage Vext, the node A, and the node det can be seen as the external power source voltage Vext increases from 0 to 5V.

FIG. 3 shows only the simulation result for the power-up signal among the simulation results of FIG. 2. It is can be seen that the timing of driving the power-up is from 1.21 to 1.67V and its variation is as much as 460 mV.

As the design rule for the semiconductor memory devices has been fined down and the core voltage used for the cell has been further lowered, in the conventional power-up generating circuit, the timing of driving the power-up has begun earlier and the initial variation of the power-up signal has been seriously deteriorated. Therefore, the conventional power-up signal generating circuit may cause many problems in the initial stability and reliability of the chip.

### SUMMARY OF THE INVENTION

In order to solve the problems, the present invention is directed to a power-up signal generating circuit capable of reducing a skew of a power-up signal for stabilizing a DRAM chip at the time of its initial operation so that the DRAM can perform its stabilized operation.

In addition, the present invention is directed to a power-up signal generating circuit capable of improving reliability of the DRAM by reducing its area and a standby current required at the time of enabling a power-up by replacing resistors in a conventional power-up signal generating circuit with an NMOS resistor.

Therefore, the present invention provide a power-up signal generating circuit, comprising: a voltage sensing unit for sensing that a potential of an external power source voltage is above a certain potential, the voltage sensing unit comprising a first switching element operated according to the external power source voltage and a resistor serially connected to the first switching element; a power-up signal generating unit for generating a power-up signal according to an output signal of the voltage sensing unit, the power-up generating unit comprising a second switching element; and a buffering unit for buffering the power-up signal from the power-up signal generating unit up to a certain potential and outputting the buffered power-up signal, wherein a timing of generating the power-up signal is controlled by the second switching element being turned on and off according to a threshold voltage of the first switching element.

### BRIEF DESCRIPTION OF THE DRAWINGS

The aforementioned aspects and other features of the present invention will be explained in the following description, taken in conjunction with the accompanying drawings, wherein:

FIG. 1 is a view illustrating a conventional power-up signal generating circuit;

FIG. 2 is a graph illustrating simulation results for the conventional power-up signal generating circuit;

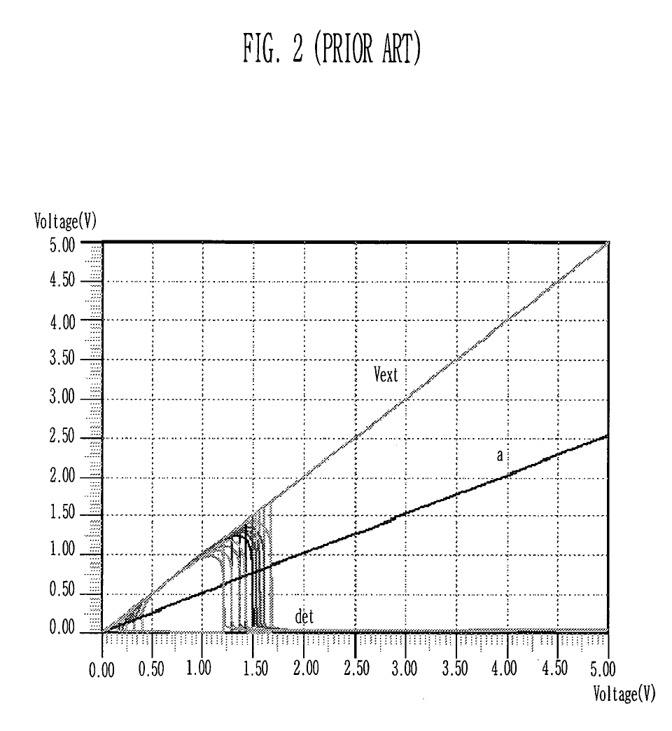

FIG. 3 is a graph illustrating a power-up variation of the conventional power-up signal generating circuit;

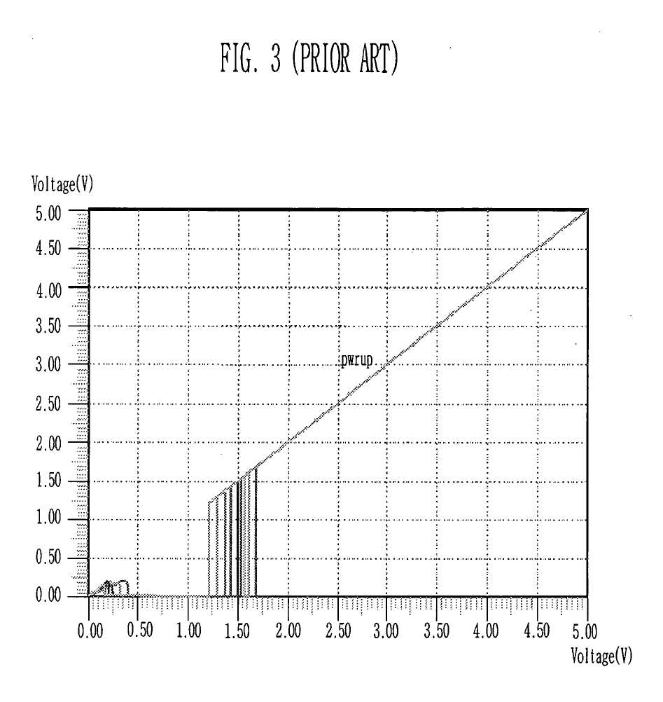

FIG. 4 is a view illustrating a power-up signal generating circuit according to the present invention;

FIG. 5 is a graph illustrating simulation results for the power-up signal generating circuit according to the present invention; and

FIG. 6 is a graph illustrating a power-up variation of the power-up signal generating circuit according to the present invention;

### DETAILED DESCRIPTION OF PREFERRED EMBODIMENTS

Now, the preferred embodiments of the present invention will be described in detail with reference to the accompanying drawings.

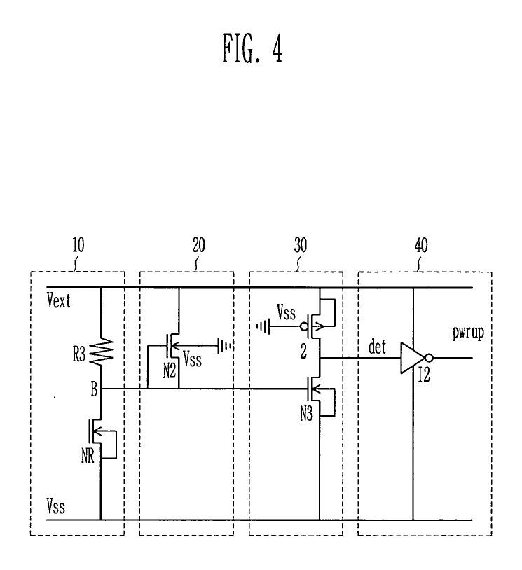

FIG. 4 is a view illustrating a power-up signal generating circuit according to the present invention.

As a whole, the power-up signal generating circuit of FIG. 4 has the same construction as the conventional one. The power-up signal generating circuit comprises a voltage sensing unit 10, a level control unit 20, a power-up signal generating unit 30, and a buffering unit 40. Here, the voltage sensing unit 10 comprises a resistor R3 and an NMOS resistor NR which are connected in serial between an external power source voltage Vext and a ground voltage Vss. The gate and drain of the NMOS resistor NR are connected to the external power source voltage Vext and the resistor R3, respectively. The ground voltage Vss is applied to the bulk and source of the NMOS resistor NR.

The level control unit 20 comprises an NMOS transistor N2, which functions as a reverse diode device, in which the ground voltage Vss is applied to the bulk. The gate and source of the NMOS transistor N2 are commonly connected to a connection node B between the resistors R3 and the NMOS resistors NR. The voltage of external power source voltage Vext is applied to the drain of the NMOS transistor N2.

In addition, the power-up signal generating unit 30 comprises a PMOS transistor P1 and an NMOS transistor N3 which are connected in serial between the external power source voltage Vext and the ground voltage Vss. The voltage of the node B and the ground voltage Vss are applied to the gate and bulk of the NMOS transistor N3, respectively.

The buffering unit 40 comprises an inverter I2 that is connected between the external power source voltage Vext and the ground voltage Vss. The inverter I2 has a function of buffering the output signal det from the power-up signal generating unit 30 and outputting the power-up signal pwrup as one of the voltage levels of the external power source voltage Vext and the ground voltage Vss.

In the power-up signal generating circuit, the voltage of the external power source voltage Vext is divided by the resistor R3 and the NMOS resistor NR, and the divided voltage is outputted to the node B. The NMOS transistor N3 is controlled by the voltage of the node B applied to its gate, so that the timing of driving the power-up signal can be determined with the NMOS transistor N3 being turned on and off.

Referring to FIG. 4, as the voltage of the external power source voltage Vext is applied, the power-up signal changes from a low state to a high state. Until the threshold voltage of the MOS transistor is 2Vt, the power-up signal is at the low state. After the threshold voltage is above 2Vt, the power-up signal is changed into the high status. At this time, a signal indicating that initialization of the chip is completed and the DRAM is able to perform its internal operation is outputted.

That is, the resistor R3 and the NMOS resistor NR are connected in serial between the external power source voltage Vext and the ground voltage Vss, and the node B is provided at the connection point between the external voltage source Vext and the ground voltage source Vss. The voltage applied to the node is inputted to the level control unit 20. When the voltage of the node B is above a certain voltage, the NMOS transistor N2 is turned on. Therefore, the voltage of the external power source voltage Vext is applied to the gate of the NMOS transistor N3, so that the NMOS transistor N3 can be operated. As a result, The NMOS transistor N3 can be controlled by the node B to which the voltage of the external voltage source Vext is applied through the resistor R3. In other words, the power-up signal is enabled by the sum of the voltage drop in the resistor R3 and the threshold voltage Vt of the NMOS transistor N3. Since the variable voltage drop in the resistors R3 is smaller than a variable resistance of a general PMOS transistor or NMOS transistor, the so-called “bulk bias effect” can be obtained. Therefore, according to the present invention, a variation can be further reduced in comparison with the conventional one. The variable voltage is the sum of the voltage drop in the resistors R3 and the threshold voltage Vt of the NMOS transistor N3.

In the conventional power-up signal generating circuit, since the voltage drop of the resistor R0 is higher than the threshold voltage of the NMOS transistor N3, variation of the power-up signal is too large. However, in the power-up signal generating circuit of the present invention, since the NMOS resistor is used, variation of the voltage drop due to the resistor R3 is drastically reduced and thus the initialization of the chip can be made in order to perform more stabilized operation.

In the conventional power-up signal generating circuit, a current of Vext/(2R) is flown through the resistors to the ground. However, in the power-up signal generating circuit of the present invention, a current of Vext/(R+NR) is flown. Therefore, the present invention is very advantageous to the standby current.

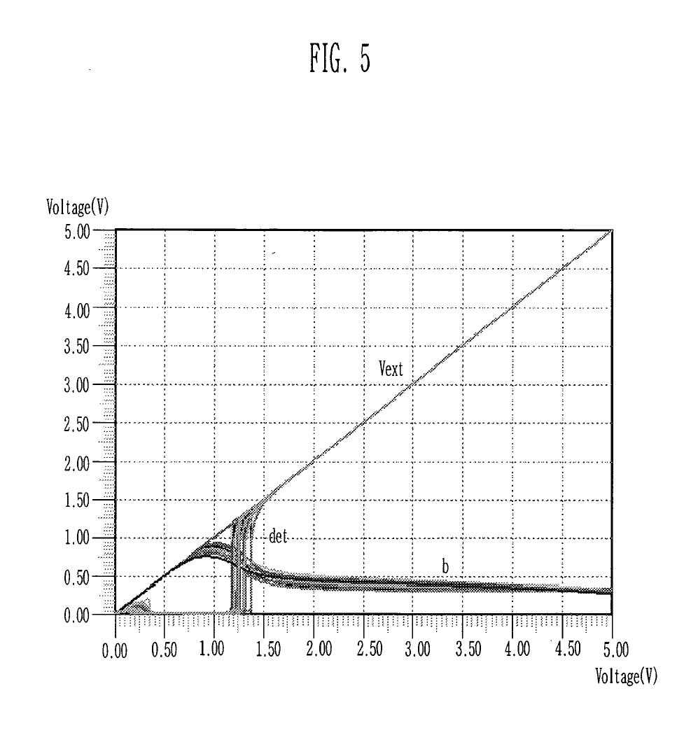

FIG. 5 shows simulation results of the power-up signal generating circuit (FIG. 4) of the present invention.

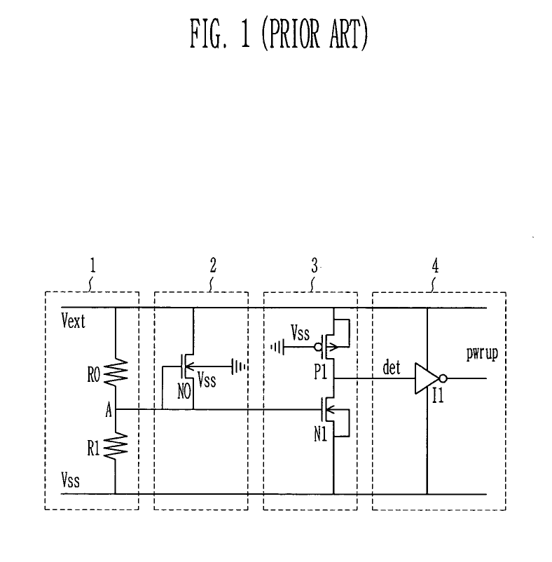

Referring to the simulation results in FIG. 5 the changes of the voltages at the external power source voltage Vext, the node B, and the node det can be seen as the external power source voltage Vext increases from 0 to 5V. Here, it can be seen that the change of the voltage at the node B according to the external power source voltage Vext is different from the change of the voltage at the node A shown in FIG. 1.

Until the NMOS resistor NR is turned on by the voltage of the external power source voltage Vext, the resistance of the NMOS resistor NR is so large that the resistor R0 cannot function as a resistor. When the NMOS resistor NR is turned on, the resistor RO is relatively larger, and thus the voltage drop occurs.

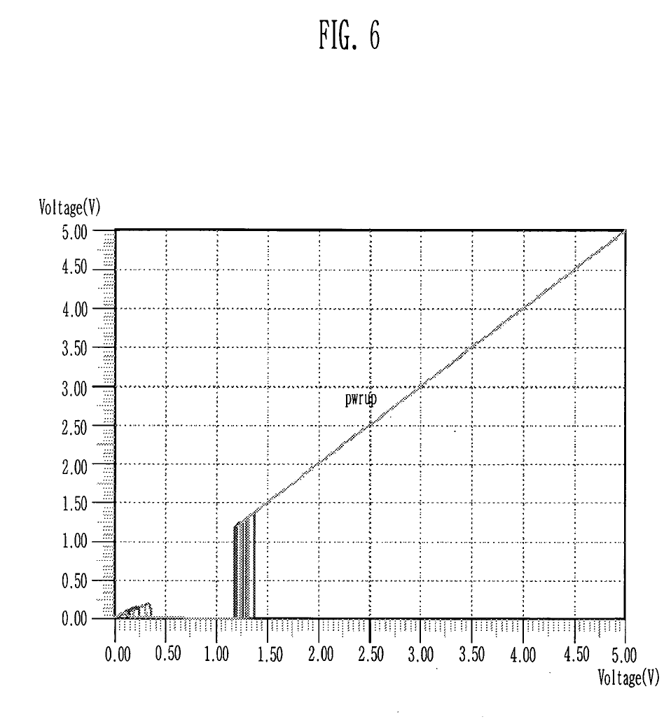

FIG. 6 shows only the simulation result of the power-up signal of the present invention. The timing of enabling the power-up signal is in a range between 1.17 and 1.37. It is can be seen that the variation is 200 mV as reduced by 56% of that of the conventional one.

As mentioned above, as the design rule of the semiconductor device has rapidly fined down and the core voltage applied to the DRAM cell has been further lowered, the process variation has been increased after the external power source voltage is applied to the device. In order to solve the problem that the process variation is increased, the power-up signal generating circuit according to the present invention can advantageously reduce the skew of the power-up signal for stabilizing the device at the time of its initial operation, so that the DRAM can perform its stabilized operation. In addition, the present invention can advantageously improve reliability of the DRAM by reducing its area and the standby current required at the time of enabling the power-up by replacing resistors in a conventional power-up signal generating circuit with the NMOS resistor, which is little dependent on such operational environment as temperature and voltage.

Although the foregoing description has been made with reference to the preferred embodiments, it is to be understood that changes and modifications of the present invention may be made by the ordinary skilled in the art without departing from the spirit and scope of the present invention and appended claims.

1. A power-up signal generating circuit, comprising:
a voltage sensing unit for sensing that a potential of an external power source voltage is above a certain potential, the voltage sensing unit comprising a first switching element operated according to the external power source voltage and a resistor serially connected to the first switching element;
a power-up signal generating unit for generating a power-up signal according to an output signal of the Voltage sensing unit, the power-up generating unit comprising a second switching element; and
a buffering unit for buffering the power-up signal from the power-up signal generating unit up to a certain potential and outputting the buffered power-up signal,
wherein a timing of generating the power-up signal is controlled by the second switching element being turned on and off according to a threshold voltage of the first switching element.

2. The power-up signal generating circuit according to claim 1, wherein the power-up signal generating circuit further comprises a level control unit which is turned on when the output voltage of the voltage sensing unit is above a certain voltage, so that an operation of the second switching element is controlled by the voltage of the external power source voltage.

3. The power-up signal generating circuit according to claim 2, wherein the level control unit comprises an NMOS transistor.

4. The power-up signal generating circuit according to claim 1, wherein the first switching element comprises an NMOS resistor, and a timing of operating the power-up signal generating unit is controlled according to the voltage divided by the resistor to which the external power source voltage is applied and the NMOS resistor to which a ground voltage is applied.

5. The power-up signal generating circuit according to claim 4, wherein a drain of the NMOS resistor are connected to the resistor, the external power source voltage is applied to a gate of the NMOS transistor, and the ground voltage is applied to a source and a bulk of the NMOS transistor.

6. The power-up signal generating circuit according to claim 1, wherein the power-up signal generating unit further comprises a pull-up element which is connected between the voltage source which generates the external power source voltage and the second switching element.

7. The power-up signal generating circuit according to claim 6, wherein the second switching element comprises an NMOS transistor, and wherein a control signal from the power sensing unit is applied to a gate of the NMOS transistor.

8. The power-up signal generating circuit according to claim 6, wherein the pull-up element comprises a PMOS transistor.
